(19) United States
(12) Patent Application Publication
(10) Pub. No.: US 2023/0401812 A1
(43) Pub. Date: Dec. 14, 2023

(54) OBJECT DETECTION SYSTEM, OBJECT DETECTION METHOD, AND OBJECT DETECTION PROGRAM

(71) Applicant: NEC Corporation, Tokyo (JP)

(72) Inventor: Mizuho Katayama, Tokyo (JP)

(73) Assignee: NEC Corporation, Tokyo (JP)

(21) Appl. No.: 18/205,686

(22) Filed: Jun. 5, 2023

(30) Foreign Application Priority Data
Jun. 14, 2022 (JP) 2022-095666

(51) Int. Cl. G06V 10/26; G06V 10/75

(52) U.S. Cl. CPC G06V 10/267; G06V 10/759; G06V 2201/07; G06V 2201/08

(57) ABSTRACT

An object detection system according to the present invention includes: an object presence region prediction means that predicts an object presence region, which is a region in which a target object exists in a current image, based on information indicating the target object detected in a past image; an object presence region fragment generation means that generates object presence region fragments, which are partial regions of the object presence region, based on the object presence region; an object detection means that detects an object detection fragment, which is a region containing the target object, based on the object presence region fragment; and a target object detection means that detects the target object from the current image using the object detection fragment.

### CROSS-REFERENCE TO RELATED APPLICATION

This application is based upon and claims the benefit of priority from Japanese patent application No. 2022-95666, filed on Jun. 14, 2022, the disclosure of which is incorporated herein in its entirety by reference.

### BACKGROUND OF THE INVENTION

### 1. Field of the Invention

The present invention relates to an object detection system, an object detection method, and an object detection program for detecting target objects in images.

### 2. Description of Related Art

An example of a method for detecting an object is described in Non-Patent Literature (NPL) 1. In the method described in Non-Patent Literature 1, based on the position of a target object detected in a certain image in the past, a region where the target object is assumed to exist in a current image is set, and a position and size of an object within the region are determined by object detection.

Specifically, the method described in Non-Patent Literature 1 predicts a rough position and size of the region containing the target object by setting the region where the target object is assumed to exist. Then, the position and size of the target object is determined for a portion of the image obtained by the prediction, which is used as the result of object detection.
NPL 1: YUXIANG YANG, et al, “Visual Tracking With Long-Short Term Based Correlation Filter,” IEEE Access, Jan. 20, 2020. https://ieeexplore.ieee.org/document/8963992

Since the computational load for object detection is generally high, it is desirable to make the target image for object detection as small as possible to speed up processing. Therefore, in order to reduce the computational load, a method of processing a portion of the image in which the target object is to be detected is considered, as in the method described in Non-Patent Literature 1.

On the other hand, for example, when the size of the target object to be detected is large, the method described in Non-Patent Literature 1 results in repeated object detection for a large-sized target object, and it is difficult to say that the computational load can be sufficiently reduced. Therefore, it is difficult to estimate the target object from the image at high speed.

### SUMMARY OF THE INVENTION

Therefore, it is an exemplary object of the present invention to provide an object detection system, an object detection method, and an object detection program that can detect a target object from an image at high speed.

An object detection system according to the present invention includes: an object presence region prediction means that predicts an object presence region, which is a region in which a target object exists in a current image, based on information indicating the target object detected in a past image; an object presence region fragment generation means that generates object presence region fragments, which are partial regions of the object presence region, based on the object presence region; an object detection means that detects an object detection fragment, which is a region containing the target object, based on the object presence region fragment; and a target object detection means that detects the target object from the current image using the object detection fragment.

An object detection method executed by computer according to the present invention includes: predicting an object presence region, which is a region in which a target object exists in a current image, based on information indicating the target object detected in a past image; generating object presence region fragments, which are partial regions of the object presence region, based on the object presence region; detecting an object detection fragment, which is a region containing the target object, based on the object presence region fragment; and detecting the target object from the current image using the object detection fragment.

An object detection program according to the present invention causing the computer to execute: an object presence region prediction process of predicting an object presence region, which is a region in which a target object exists in a current image, based on information indicating the target object detected in a past image; an object presence region fragment generation process of generating object presence region fragments, which are partial regions of the object presence region, based on the object presence region; an object detection process of detecting an object detection fragment, which is a region containing the target object, based on the object presence region fragment; and a target object detection process of detecting the target object from the current image using the object detection fragment.

According to the present invention, a target object can be detected from an image at high speed.

### BRIEF DESCRIPTION OF THE DRAWINGS

FIG. 1 is a block diagram illustrating a configuration example of a first exemplary embodiment of an object detection system according to the disclosure.

FIG. 2 is an explanatory diagram illustrating an example of object detection results in a past image and object presence regions.

FIG. 3 is an explanatory diagram illustrating an example of the process of generating a group of object presence region fragments.

FIG. 4 is an explanatory diagram illustrating an example of the process of detecting object detection fragments.

FIG. 5 is an explanatory diagram illustrating an example of the process of detecting a target object.

FIG. 6 is a flowchart illustrating an example of the operation of the object detection system of the first exemplary embodiment.

FIG. 7 is a block diagram illustrating a configuration example of a second exemplary embodiment of an object detection system according to the disclosure.

FIG. 8 is an explanatory diagram illustrating an example of the process of predicting object presence regions.

FIG. 9 is a flowchart illustrating an example of the operation of the object detection system of the second exemplary embodiment.

FIG. 10 is a block diagram illustrating an outline of an object detection system according to the disclosure.

### DETAILED DESCRIPTION OF THE INVENTION

### Description of the Preferred Embodiments

The following is a description of the exemplary embodiment of the disclosure with reference to the drawings.

In the following description, the image in which the target object is to be detected is referred to as a current image. The current image is, for example, an image sequentially captured by a fixed-point camera such as a surveillance camera. In the following description, the case in which the target object is a vehicle will be illustrated as a concrete example, but the target object is not limited to vehicles.

In this exemplary embodiment, it is also assumed that the target object has already been detected from images taken in the past than the current image (hereinafter referred to as a past image), and that information indicating the target object detected from the past images has been calculated. The information indicating the target object includes information indicating the region where the target object exists and the image from which the portion containing the target object is extracted (hereinafter referred to as a past partial image).

The presence region of the target object is the region containing the target object, for example, a rectangular region represented by the top-left vertex coordinate and the width and height of the object. Alternatively, the presence region of the target object may be a rectangular region represented by the top-left coordinate and bottom-right vertex coordinate.

### Exemplary Embodiment 1

[Description of Configuration]

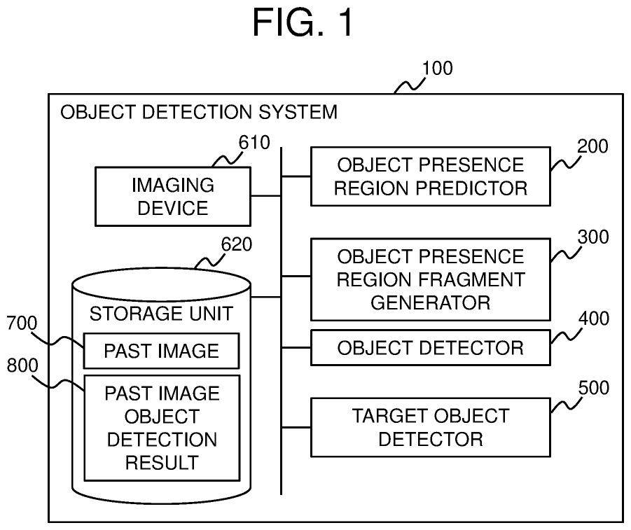

FIG. 1 is a block diagram illustrating a configuration example of a first exemplary embodiment of an object detection system according to the disclosure. As shown in FIG. 1, an object detection system 100 of the present exemplary embodiment includes an object presence region predictor 200, an object presence region fragment generator 300, an object detector 400, a target object detector 500, an imaging device 610, and a storage unit 620.

The storage unit 620 stores various information necessary for the processing performed by the object detection system 100 in this exemplary embodiment. The storage unit 620 also stores a past image 700 and a past image object detection result 800 described above. The past image object detection result 800 is information indicating a target object detected in the past image, specifically, information indicating the region where the target object exists or an image from which the portion containing the target object was extracted.

The object detection system 100 in this exemplary embodiment calculates and outputs object detection results from the current image and the past image object detection results 800 for the past image 700. The first exemplary embodiment describes the case where the information indicating the target object detected in the past image is the information indicating a presence region of the target object.

The imaging device 610 is a device installed at a predetermined location to capture images of the detection target. Specifically, the imaging device 610 acquires a current image as a result of the image capture. In this exemplary embodiment, it is assumed that the angle of view when the imaging device 610 captures an image does not change over time, and the angle of view for capturing the current image and the past image is also assumed to be the same.

The object presence region predictor 200 predicts a region where the target object exists in the current image (hereinafter referred to as the object presence region) based on information indicating the target object detected in the past image 700 (i.e., the past image object detection result 800). The method by which the object presence region predictor 200 predicts the object presence region is arbitrary. For example, the object presence region predictor 200 may predict the object presence region from the past image object detection result 800 based on a dynamic model such as a Kalman filter.

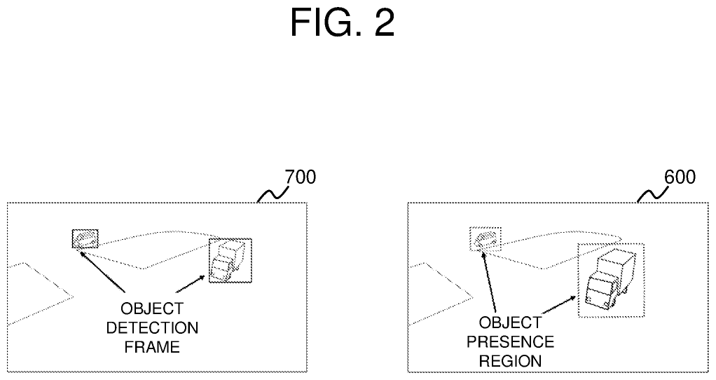

FIG. 2 is an explanatory diagram illustrating an example of object detection results in a past image and object presence regions. As illustrated in FIG. 2, it is assumed that an object detection frame indicating the presence region of a target object is detected in the past image 700 as information indicating the target object. In this case, the object presence region predictor 200 predicts the object presence region in a current image 600 using this object detection frame as information indicating the target object. As illustrated in FIG. 2, the object presence region may be a rectangular region represented by the upper left vertex coordinate, width, and height. As a result of the prediction by the object presence region predictor 200, the object presence region can be said to be a region that has a high probability of containing the target object.

The object presence region fragment generator 300 divides the object presence region and generates a partial region of the object presence region (hereinafter referred to as an object presence region fragment). In doing so, the object presence region fragment generator 300 divides the object presence region so that the object presence region fragment contains a part of the target object to be detected. In other words, the object presence region fragment is an image in which the partial image of the current image 600 obtained from the information of the object presence region is further divided, and is an image with a smaller spatial size than the object presence region.

Since the object detector 400, described below, performs target object detection processing on the object presence region fragments, the divided target object is assumed to be large enough to be detected by the object detector 400. Therefore, it is preferable for the object presence region fragment generator 300 to generate the object presence region fragments by bisecting the object presence region vertically or horizontally.

The object presence region fragment generator 300 may also generate the object presence region fragment with a position of the object presence region fragment in the object presence region added. Examples of the position of the object presence region fragment contain the position with respect to the object presence region before segmentation, for example, information indicating that the object was present on the right side of the segmented image, or information indicating that the object was present at the top. An example of the position of the object presence region fragment is, for example, a relative position with respect to the upper left coordinate. By adding such position information, the processing described below (specifically, the process of detecting the object presence region) can be performed with high accuracy. The processing using this position information is described below.

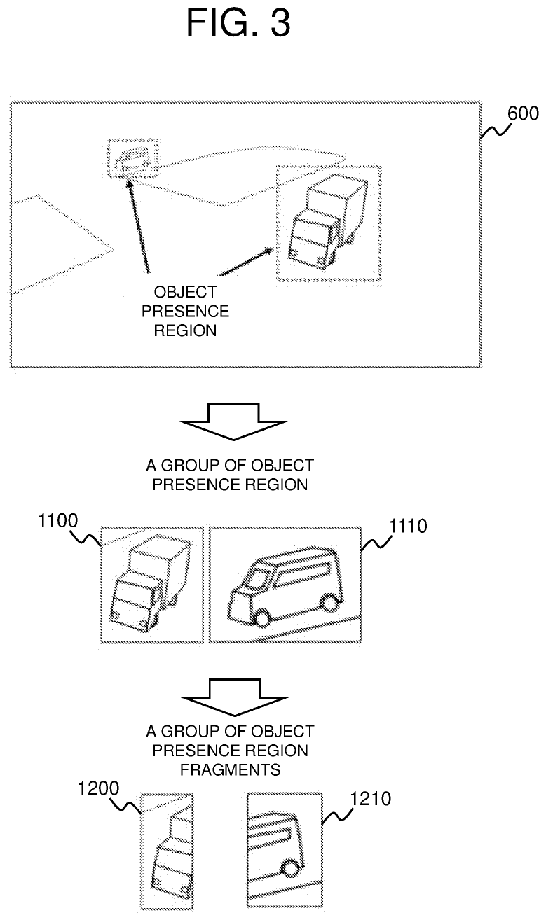

FIG. 3 is an explanatory diagram illustrating an example of the process of generating a group of object presence region fragments. When multiple object presence regions are predicted from the current image, the object presence region fragment generator 300 generates object presence region fragments from each object presence region. The example shown in FIG. 3 indicates that object presence region fragment generator 300 generates object presence region fragment 1200 from object presence region 1100 and generates object presence region fragment 1210 from object presence region 1110.

The object detector 400 detects the region containing the target object (hereinafter referred to as an object detection fragment) based on the object presence region fragment. The method of representing object detection fragments is arbitrary. For example, the object detection fragment may be a rectangular region represented by the upper left vertex coordinate, width and height as well as the object detection result.

The method by which the object detector 400 detects the region containing the target object (i.e., object detection fragment) is also arbitrary. In other words, the object detector 400 does not necessarily need to be a special object detector for detecting the object detection fragment. The object detector 400 is arbitrary as long as it is a detector capable of detecting the target object from an image that contains a portion of the target object. The object detector 400 may be a commonly used object detector, for example, Yolo (You Look Only Once).

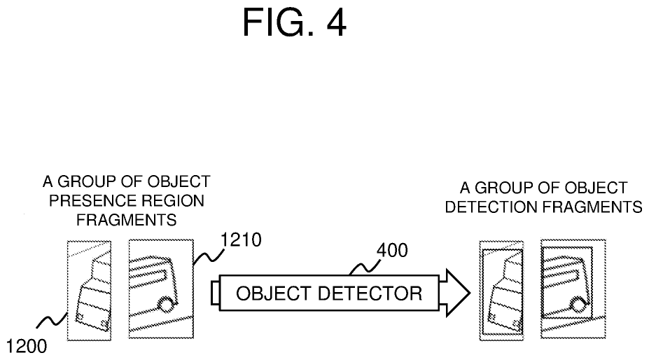

FIG. 4 is an explanatory diagram illustrating an example of the process of detecting object detection fragments. The example shown in FIG. 4 indicates that object detection fragments specifying the region of the vehicle are detected from an object presence region fragment 1200 and an object presence region fragment 1210 each containing a portion of the vehicle as the target object.

The target object detector 500 detects the target object from the current image using the object detection fragment. That is, the target object detector 500 calculates the object detection result in the current image 600 from the object detection fragments and the past image object detection result 800 in the past image 700.

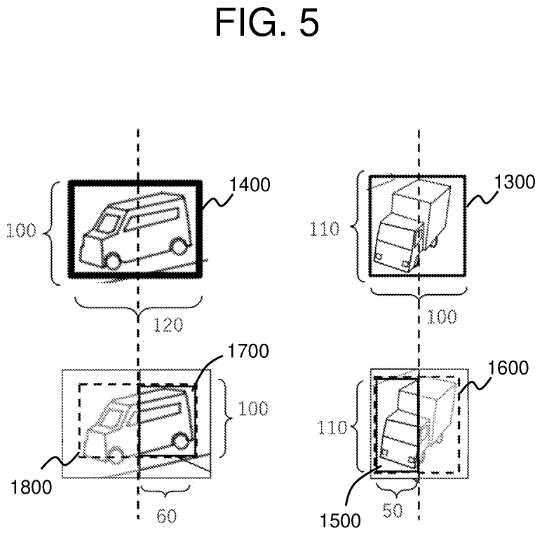

The following is a specific explanation of how the target object detector 500 detects the target object. FIG. 5 is an explanatory diagram illustrating an example of the process of detecting a target object. In the example shown in FIG. 5, it is assumed that the object presence region predictor 200 predicts the object presence region using the object detection frame indicating the presence region of the target object detected from the past image as information indicating the target object. Specifically, it is assumed that an object detection frame 1400 and an object detection frame 1300 were predicted by the object presence region predictor 200, respectively.

In this case, the target object detector 500 estimates the object detection frame indicating the presence region of the target object in the current image based on the object detection frame detected in the past image and the object detection fragments. Specifically, the target object detector 500 estimates the horizontal size or vertical size of the object detection frame in the current image based on the vertical size and horizontal size (hereinafter referred to as the vertical and horizontal size) of the detection frame acquired from the past image and the vertical and horizontal size of the detection frame acquired from the object detection fragment. The unit of size should be predetermined, such as pixels.

For example, it is assumed that in FIG. 5, the vertical and horizontal size of the object detection frame 1400 acquired from the past image are 120 and 100, respectively, and the vertical and horizontal size of the object detection fragment 1700 are 60 and 100, respectively. In this case, since the vertical size of the object detection fragment 1700 is 100, the target object detector 500 estimates the horizontal size of the object detection frame 1800 in the current image to be 100*120/100=120. This is a variant of the formula “120/100=horizontal size of object detection frame 1800/100”. The object contained in this object detection frame 1800 corresponds to the final object detection result.

Similarly, in FIG. 5, it is assumed that the vertical and horizontal size of the object detection frame 1300 acquired from the past image are 100 and 110, respectively, and that the vertical and horizontal size of the object detection fragment 1500 are 50 and 110, respectively. In this case, since the vertical size of the object detection fragment 1500 is 110, the target object detector 500 estimates the horizontal size of the object detection frame 1600 in the current image to be 110*100/110=100.

It is assumed that the object presence region fragment generator 300 had generated the object presence region fragments with the position of the object presence region fragment in the object presence region added, as described above. In that case, the target object detector 500 would be able to estimate which part of the object presence region each object detection fragment was located in, and thus be able to determine whether the size of the object detection frame should be estimated in the vertical direction or horizontal direction.

For example, it is assumed that information indicating that the object is located in the right half of the segmented image is added to the object presence region fragment 1210 illustrated in FIG. 4. In this case, the object detection fragment 1700 illustrated in FIG. 5 can also hold information indicating that it is located in the right half of the segmented image. This leads the target object detector 500 to determine that after calculating the horizontal size of the object detection frame 1800, it is sufficient to calculate the upper left vertex coordinates of the object detection frame.

In the example shown in FIG. 5, the target object detector 500 estimates the upper left vertex coordinate (x, y) of the object detection frame=(x′, upper left vertex y-coordinate of the object detection frame 1800). Here, x′=upper left vertex x-coordinate of object detection fragment 1700−(horizontal size of object detection frame 1800−horizontal size of object detection fragment 1700).

The target object detector 500 then outputs the detection results of the target object.

The object presence region predictor 200, the object presence region fragment generator 300, the object detector 400, and the target object detector 500 are realized by a processor of a computer (for example, a CPU (Central Processing Unit), or a GPU (Graphics Processing Unit)) that operates according to a program (object detection program).

For example, the program may be stored in the storage unit 620 of the object detection system 100, and the processor may read the program and, operate as the object presence region predictor 200, the object presence region fragment generator 300, the object detector 400, and the target object detector 500 according to the program. Also, the functions of the object detection system 100 may be provided in a SaaS (Software as a Service) format.

The object presence region predictor 200, the object presence region fragment generator 300, the object detector 400, and the target object detector 500 may each be realized by dedicated hardware. Some or all of the components of each device may be realized by general-purpose or dedicated circuitry, processors, or combinations thereof.

These may comprise a single chip or a plurality of chips connected through a bus. Some or all of the components of each device may be realized by a combination of the above-described circuits, etc. and a program.

When some or all of each component of the object detection system 100 is realized by a plurality of information processing devices, circuits, or the like, the plurality of information processing devices, circuits, or the like may be centrally located or distributed.

[Description of Operation]

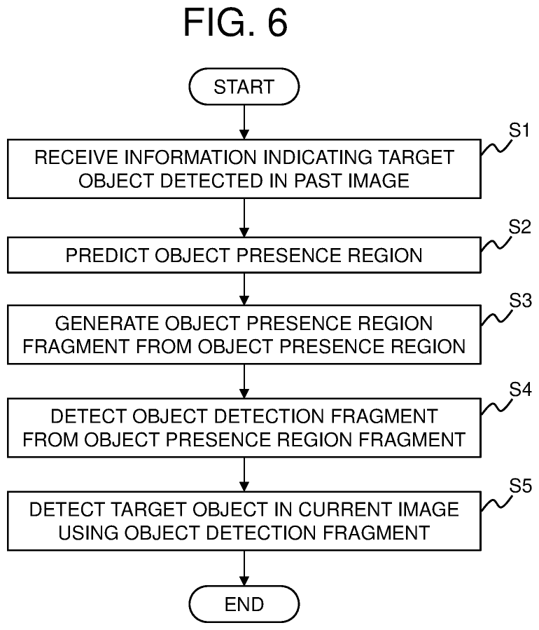

Next, an operation example of this exemplary embodiment of the object detection system will be described. FIG. 6 is a flowchart illustrating an example of the operation of the object detection system 100 of the first exemplary embodiment.

The object presence region predictor 200 receives the current image and the object detection results for the past images (step S1). That is, the object presence region predictor 200 receives information indicating the target object detected in the past image as the object detection result. The object presence region predictor 200 predicts the object presence region for the current image based on the object detection results for the past image (Step S2). The object presence region fragment generator 300 generates object presence region fragments from the object presence region (Step S3). The object detector 400 performs object detection on a group of object presence region fragments and calculates a group of object detection fragments (Step S4). In other words, the object detector 400 detects object detection fragments from the object presence region fragments. Then, the target object detector 500 estimates the object detection result from the group of object detection fragments and the object detection result for the past image, and makes it the object detection result for the current image (Step S5). In other words, the target object detector 500 detects the target object in the current image using the object detection fragments.

### Description of Effect

Next, the effects of this exemplary embodiment will be explained. As described above, in this exemplary embodiment, the object presence region predictor 200 predicts the object presence region based on information indicating the target object detected in the past image, and the object presence region fragment generator 300 generates object presence region fragments based on the object presence region. The object detector 400 detects object detection fragments based on the object presence region fragments, and the target object detector 500 detects the target object from the current image using the object detection fragments. Thus, the target object can be detected at high speed from the image.

In other words, the object detection system 100 in this exemplary embodiment performs object detection using only one object presence region fragment that is divided from the object presence region (i.e., without using the other object presence region fragment), rather than the object presence region as is, which enables fast inference and reduces the inference time for object detection. In other words, it can be computed at high speed. This is because the spatial size of the image used to detect the target object is reduced. In addition, because the object detection system 100 further uses object detection fragments to estimate object detection results, it can output object detection results that contain the complete target object.

### Exemplary Embodiment 2

[Description of Configuration]

Next, a second exemplary embodiment of the object detection system according to the present invention will be described. The second exemplary embodiment describes a case in which the information indicating a target object detected from a past image is an image from which the portion containing the target object has been extracted (i.e., a past partial image).

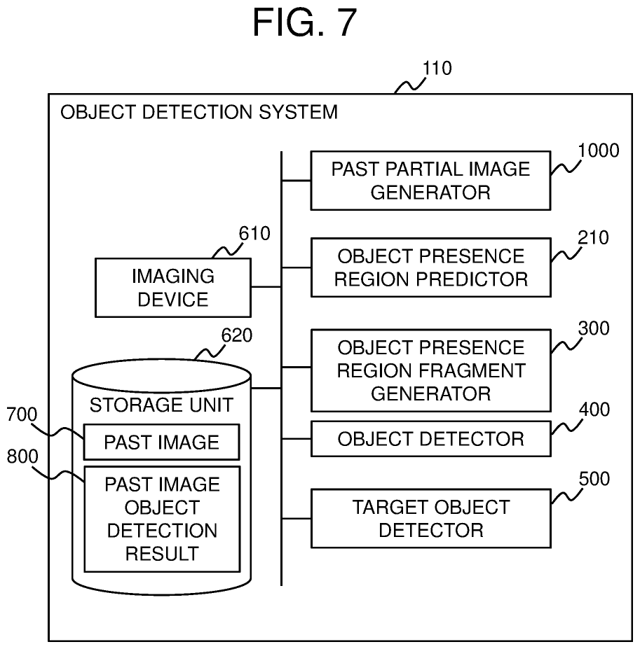

As shown in FIG. 7, an object detection system 110 of this exemplary embodiment includes an object presence region predictor 210, an object presence region fragment generator 300, an object detector 400, a target object detector 500, an imaging device 610, a storage unit 620, and a past partial image generator 1000. In other words, the object detection system 110 of this exemplary embodiment differs from the object detection system 100 of the first exemplary embodiment in that it further includes a past partial image generator 1000 and includes an object presence region predictor 210 instead of the object presence region predictor 200. Other configurations are similar to the first exemplary embodiment.

The past partial image generator 1000 generates a past partial image from the past image and the object detection results for the past image. As described above, a past partial image is an image from which the portion of the past image containing the target object is extracted. The method by which the past partial image generator 1000 generates the past partial image is arbitrary, and any known object detection method may be used.

The object presence region predictor 210 predicts the object presence region using the past partial images as information indicating the target object. Specifically, the object presence region predictor 210 predicts the object presence region based on the correlation between the past partial images and the current image.

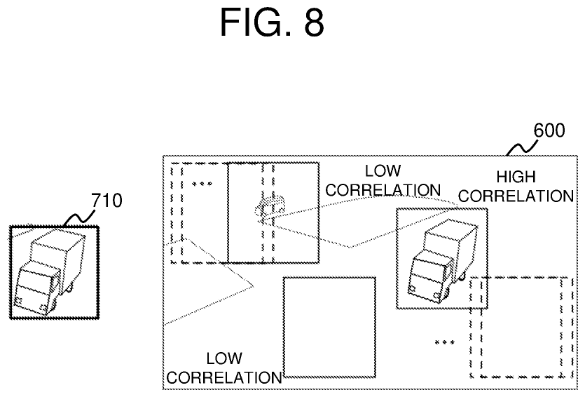

FIG. 8 is an explanatory diagram illustrating an example of the process of predicting object presence regions. The example shown in FIG. 8 illustrates that the object presence region predictor 210 calculates the correlation between a past partial image 710 and an object in a current image 600 as a classical method of calculating the correlation coefficient using pixel values of the image. Specifically, the example shown in FIG. 8 indicates that the object presence region predictor 210 predicts the object presence region by calculating a plurality of correlations between the past partial image and a portion of the current image corresponding to that position while sliding the past partial image with respect to the current image. The object presence region predictor 210 may, for example, predict the current image of the position for which a correlation exceeding a predetermined value is calculated as the object presence region.

For example, for all candidates of a group of the object presence region in the current image, the object presence region predictor 210 may calculate the correlation with the past partial image and predict the candidate with the highest correlation as the object presence region.

Alternatively, the object presence region predictor 210 may use a deep learning model that takes two images as input and outputs the point of highest correlation between the two images. Such a deep learning model is, for example, a Siam (Siamese) network. In this case, the object presence region predictor 210 may input the past partial image and the current image to the deep learning model and predict the output result as the object presence region.

The past partial image generator 1000, the object presence region predictor 210, the object presence region fragment generator 300, the object detector 400, and the target object detector 500 are realized by a processor of a computer (for example, a CPU or a GPU) that operates according to a program (object detection program).

[Description of Operation]

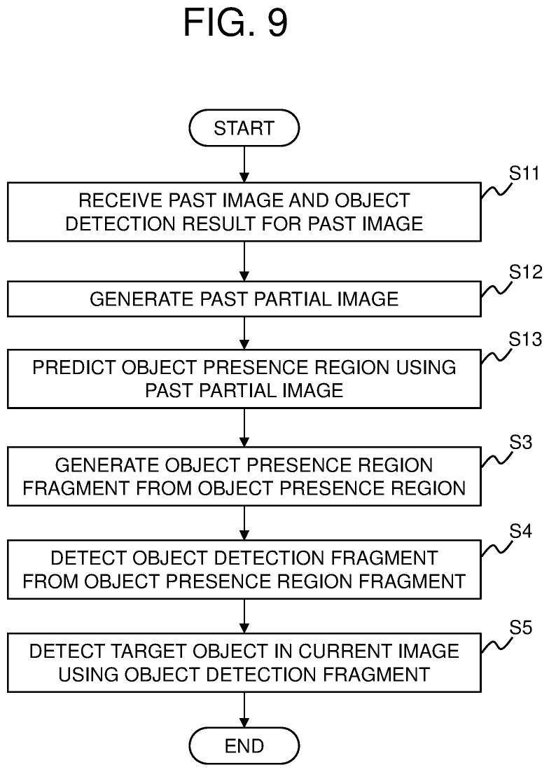

Next, an operation example of this exemplary embodiment of object detection system will be described. FIG. 9 is a flowchart illustrating an example of the operation of the object detection system 110 of the second exemplary embodiment.

The past partial image generator 1000 receives the past image and the object detection results for the past image (step S11) and generates the past partial image (step S12). The object presence region predictor 210 predicts the object presence region using the past partial images (step S13). The subsequent process is the same as the process from step S3 onward as illustrated in FIG. 6.

### Description of Effect

Next, the effects of this exemplary embodiment will be explained. As described above, in this exemplary embodiment, the object presence region predictor 210 predicts the object presence region based on the correlation between the past partial image and the current image. Therefore, as in the first exemplary embodiment, target objects can be detected from images at high speed.

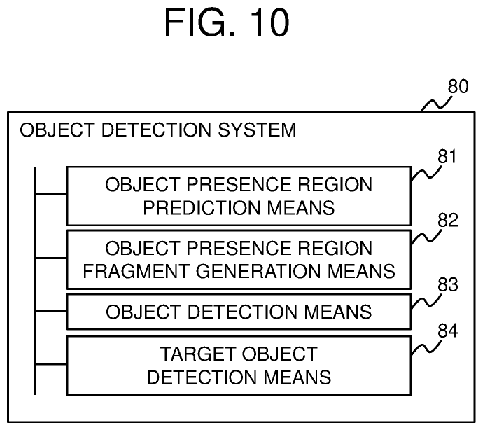

Next, an overview of the present invention will be described. FIG. 10 is a block diagram illustrating an outline of an object detection system according to the disclosure. The object detection system 80 according to the present invention includes: an object presence region prediction means 81 (e.g., object presence region predictor 200) that predicts an object presence region, which is a region in which a target object exists in a current image, based on information indicating the target object detected in a past image; an object presence region fragment generation means 82 (e.g., object presence region fragment generator 300) that generates object presence region fragments, which are partial regions of the object presence region, based on the object presence region; an object detection means 83 (e.g., object detector 400) that detects an object detection fragment, which is a region containing the target object, based on the object presence region fragment; and a target object detection means 84 (e.g., target object detector 500) that detects the target object from the current image using the object detection fragment.

Such a configuration a target object can be detected from an image at high speed.

The object presence region prediction means 81 may predict the object presence region using an object detection frame indicating a presence region of the target object detected from the past image as information indicating the target object, and the target object detection means 84 may estimates an object detection frame indicating a presence region of the target object in the current image based on the object detection frame and the object detection fragment.

The target object detection means 84 may estimate horizontal size or vertical size of the object detection frame in the current image based on vertical and horizontal size of the object detection frame acquired from the past image and vertical and horizontal size of a detection frame acquired from the object detection fragment.

The object presence region fragment generation means 82 may generate the object presence region fragment with a position of the object presence region fragment in the object presence region.

Specifically, the object presence region fragment generation means 82 may generate the object presence region fragment with a position with respect to the object presence region before division as the position of the object presence region fragment.

The object presence region fragment generation means 82 may generate the object presence region fragment by bisecting the object presence region vertically or horizontally.

Otherwise, the object presence region prediction means 81 may use a past partial image, which is an image obtained by extracting a portion containing the target object from the past image, as information indicating the target object, and based on a correlation between the past partial image and the current image, to predict the object presence region.

Specifically, the object presence region prediction means 81 may predict the object presence region based on a plurality of correlations calculated while sliding the past partial image with respect to the current image.

Otherwise, the object presence region prediction means 81 may use a deep learning model that takes two images as input and outputs the point of highest correlation between the two images to predict the object presence region based on the past partial image and the current image.

Some or all of the above exemplary embodiments may also be described in the following supplementary notes, but are not limited to.

(Supplementary note 1) An object detection system comprising:
an object presence region prediction means that predicts an object presence region, which is a region in which a target object exists in a current image, based on information indicating the target object detected in a past image;
an object presence region fragment generation means that generates object presence region fragments, which are partial regions of the object presence region, based on the object presence region;
an object detection means that detects an object detection fragment, which is a region containing the target object, based on the object presence region fragment; and a target object detection means that detects the target object from the current image using the object detection fragment.

(Supplementary note 2) The object detection system according to Supplementary note 1, wherein
the object presence region prediction means predicts the object presence region using an object detection frame indicating a presence region of the target object detected from the past image as information indicating the target object; and
the target object detection means estimates an object detection frame indicating a presence region of the target object in the current image based on the object detection frame and the object detection fragment.

(Supplementary note 3) The object detection system according to Supplementary note 2, wherein
the target object detection means estimates horizontal size or vertical size of the object detection frame in the current image based on vertical and horizontal size of the object detection frame acquired from the past image and vertical and horizontal size of a detection frame acquired from the object detection fragment.

(Supplementary note 4) The object detection system according to any one of Supplementary notes 1 to 3, wherein
the object presence region fragment generation means generates the object presence region fragment with a position of the object presence region fragment in the object presence region.

(Supplementary note 5) The object detection system according to Supplementary note 4, wherein
the object presence region fragment generation means generates the object presence region fragment with a position with respect to the object presence region before division as the position of the object presence region fragment.

(Supplementary note 6) The object detection system according to any one of Supplementary notes 1 to 3, wherein
the object presence region fragment generation means generates the object presence region fragment by bisecting the object presence region vertically or horizontally.

(Supplementary note 7) The object detection system according to Supplementary note 1, wherein
the object presence region prediction means uses a past partial image, which is an image obtained by extracting a portion containing the target object from the past image, as information indicating the target object, and based on a correlation between the past partial image and the current image, to predict the object presence region.

(Supplementary note 8) The object detection system according to Supplementary note 1, wherein
the object presence region prediction means predicts the object presence region based on a plurality of correlations calculated while sliding the past partial image with respect to the current image.

(Supplementary note 9) The object detection system according to Supplementary note 7, wherein
the object presence region prediction means uses a deep learning model that takes two images as input and outputs the point of highest correlation between the two images to predict the object presence region based on the past partial image and the current image.

(Supplementary note 10) An object detection method executed by computer comprising:
predicting an object presence region, which is a region in which a target object exists in a current image, based on information indicating the target object detected in a past image;
generating object presence region fragments, which are partial regions of the object presence region, based on the object presence region;
detecting an object detection fragment, which is a region containing the target object, based on the object presence region fragment; and
detecting the target object from the current image using the object detection fragment.

(Supplementary note 11) An object detection program causing the computer to execute:
an object presence region prediction process of predicting an object presence region, which is a region in which a target object exists in a current image, based on information indicating the target object detected in a past image;
an object presence region fragment generation process of generating object presence region fragments, which are partial regions of the object presence region, based on the object presence region;
an object detection process of detecting an object detection fragment, which is a region containing the target object, based on the object presence region fragment; and
a target object detection process of detecting the target object from the current image using the object detection fragment.

As described above, although the present invention is described with reference to the exemplary embodiments and examples, the present invention is not limited to the aforementioned exemplary embodiments and examples. Various changes that can be understood by those skilled in the art within the scope of the present invention can be made to the configurations and details of the present invention.

The invention is suitably applied to an object detection system that detects target objects in images. For example, the invention can be suitably applied to transportation systems that detect vehicles and people by object detection, and inspection systems that inspect products by detecting them by object detection.

What is claimed is:

1. An object detection system comprising:
a memory storing instructions; and
one or more processors configured to execute the instructions to:
predict an object presence region, which is a region in which a target object exists in a current image, based on information indicating the target object detected in a past image;
generate object presence region fragments, which are partial regions of the object presence region, based on the object presence region;
detect an object detection fragment, which is a region containing the target object, based on the object presence region fragment; and
detect the target object from the current image using the object detection fragment.

2. The object detection system according to claim 1, wherein the processor is configured to execute the instructions to:
predict the object presence region using an object detection frame indicating a presence region of the target object detected from the past image as information indicating the target object; and
estimate an object detection frame indicating a presence region of the target object in the current image based on the object detection frame and the object detection fragment.

3. The object detection system according to claim 2, wherein the processor is configured to execute the instructions to
estimate horizontal size or vertical size of the object detection frame in the current image based on vertical and horizontal size of the object detection frame acquired from the past image and vertical and horizontal size of a detection frame acquired from the object detection fragment.

4. The object detection system according to claim 1, wherein the processor is configured to execute the instructions to
generate the object presence region fragment with a position of the object presence region fragment in the object presence region.

5. The object detection system according to claim 4, wherein the processor is configured to execute the instructions to
generate the object presence region fragment with a position with respect to the object presence region before division as the position of the object presence region fragment.

6. The object detection system according to claim 1, wherein the processor is configured to execute the instructions to
generate the object presence region fragment by bisecting the object presence region vertically or horizontally.

7. The object detection system according to claim 1, wherein the processor is configured to execute the instructions to
use a past partial image, which is an image obtained by extracting a portion containing the target object from the past image, as information indicating the target object, and based on a correlation between the past partial image and the current image, to predict the object presence region.

8. The object detection system according to claim 1, wherein the processor is configured to execute the instructions to
predict the object presence region based on a plurality of correlations calculated while sliding the past partial image with respect to the current image.

9. An object detection method executed by computer comprising:
predicting an object presence region, which is a region in which a target object exists in a current image, based on information indicating the target object detected in a past image;
generating object presence region fragments, which are partial regions of the object presence region, based on the object presence region;
detecting an object detection fragment, which is a region containing the target object, based on the object presence region fragment; and
detecting the target object from the current image using the object detection fragment.

10. A non-transitory computer readable information recording medium storing an object detection program for causing a computer:
to predict an object presence region, which is a region in which a target object exists in a current image, based on information indicating the target object detected in a past image;
to generate object presence region fragments, which are partial regions of the object presence region, based on the object presence region;
to detect an object detection fragment, which is a region containing the target object, based on the object presence region fragment; and
to detect the target object from the current image using the object detection fragment.
